(19) United States
(12) Patent Application Publication
(10) Pub. No.: US 2004/0025244 A1
(43) Pub. Date: Feb. 12, 2004

(54) Adjustable water therapy combination

(76) Inventors: Casey Loyd, Pomona, CA (US); Pedro Vargas, Pomona, CA (US)

Correspondence Address: Jennifer Ankai, 9th Floor, 225 South Lake Avenue, Pasadena, CA, 91101, US

(21) Appl. No.: 10/435,328

(22) Filed: May 8, 2003

Related U.S. Application Data
(63) Continuation-in-part of application No. 10/099,834, filed on Mar. 14, 2002, now abandoned.

(51) Int. Cl. A47K 3/00; A61H 33/02; A47K 3/10

(52) U.S. Cl. 4/541.1

(57) ABSTRACT

An adjustable water therapy combination has a water basin for retaining a human patient and a pump driven water circulation system which provides streams of pulsating water to a patient through openings in the water basin. The pump is driven by an electric motor, which is controlled by a controller capable of turning the motor on and off. The controller is also capable of adjusting the pulsing of the water discharged from the pump as to frequency, duration and, optionally, amplitude. A control panel for adjusting the settings on the pump motor controller is disposed at a location where it is readily accessible to the patient, so that the patient can easily and conveniently adjust the pulsations of water without having to exit the water basin.

### FIELD OF THE INVENTION

This invention relates generally to water therapy systems such as systems disposed within therapy spas and therapy bath tubs.

### BACKGROUND OF THE INVENTION

The use of water therapy whereby pulsating jets of water are directed to various portions of a human patient disposed within some sort of water basin are becoming increasingly popular.

There is a problem, however, with the water therapy systems which are presently known. That problem arises from the fact that the frequency and the duration of the water pulses are not readily adjustable by the patient, except by the incorporation of complex and expensive equipment.

Accordingly, there is a need for an adjustable water therapy system wherein the therapeutic pulsating water is readily adjustable by a patient disposed within the water basin.

### SUMMARY OF THE INVENTION

The invention satisfies this need. The invention is an adjustable water therapy combination comprising (a) a water basin capable of retaining a human being partially submerged below a level of water, the water basin having at least one drain opening and having a plurality of water input openings, (b) a water pump having a suction side and a discharged side, (c) water circulation conduits connecting the at least one water basin drain opening to the suction side of the pump and connecting the discharge side of the pump to the plurality of water input openings in the water basin, (d) an electric motor for driving the pump, (e) a controller capable of turning the motor on and off, the controller also having settings for adjusting the pulsing of water discharged from the pump, both as to frequency and duration, the controller being capable of pulsing the electric motor on and off so as to drive the pump in pulsing flow mode in a plurality of pulsing flow frequencies and durations, and (f) a control panel operatively connected to the controller and being accessible to a user disposed within the water basin, for adjusting the settings on the controller and for adjusting the frequency and duration of flow pulsations from the pump.

In a preferred embodiment of the invention, the controller is capable of adjusting the pulsing of water discharged from the pump as to frequency, duration and amplitude.

### DESCRIPTION OF THE DRAWINGS

These and other features, aspects and advantages of the present invention will become better understood with reference to the following description, appended claims and accompanying drawings where:

FIG. 1 is a diagrammatic view of a water therapy combination having features of the invention;

FIG. 2 is a diagrammatic illustration of a pump, motor and controller combination useful in the water therapy combination illustrated in FIG. 1;

FIG. 3 is a diagrammatic illustration of a first control panel useable in the water therapy combination illustrated in FIG. 1; and

FIG. 4 is a diagrammatic illustration of a second control panel useable in the water therapy combination illustrated in FIG. 1.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

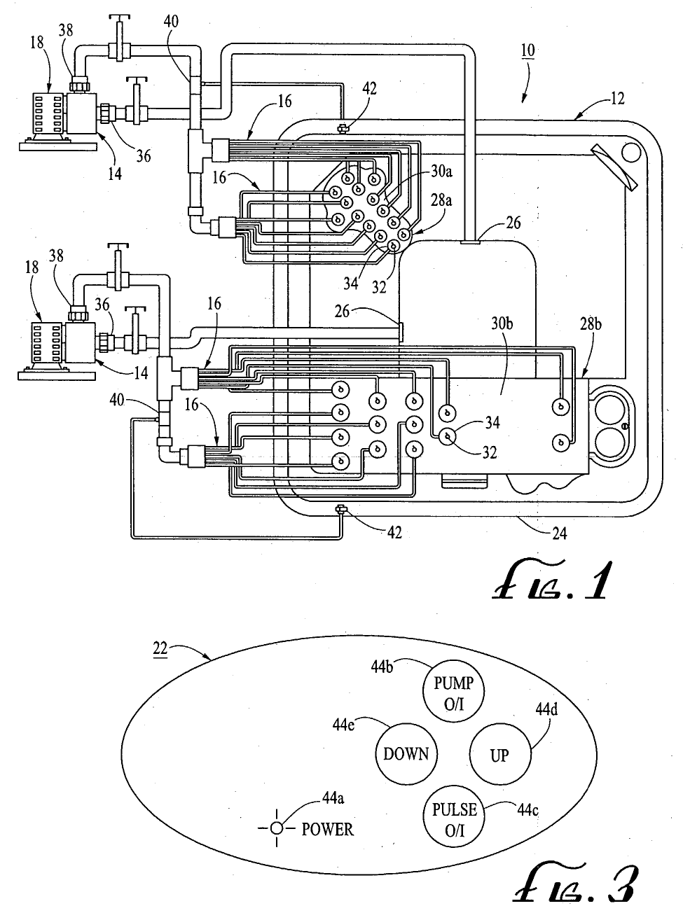

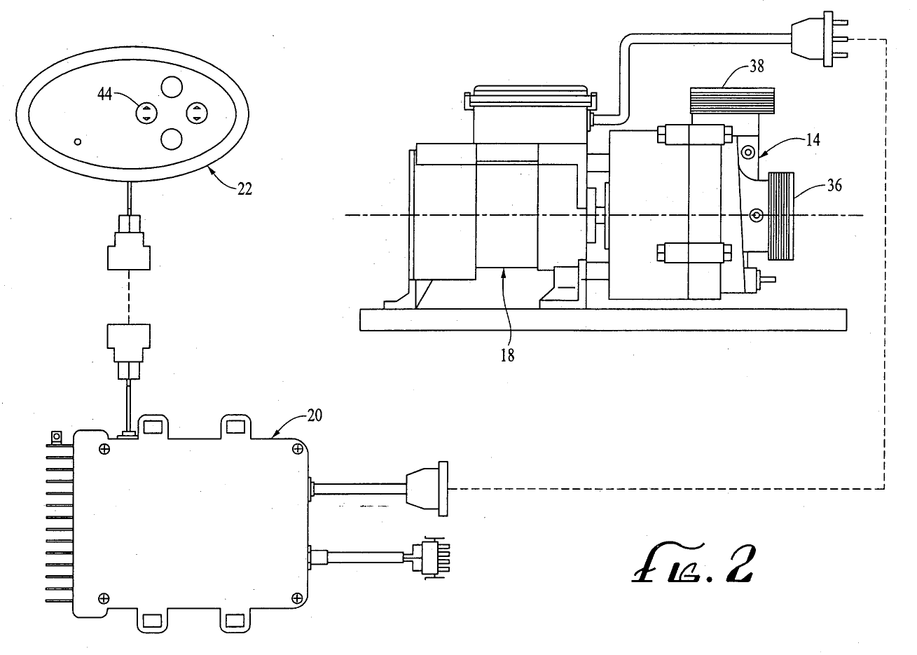

The invention is an adjustable water therapy combination 10 comprising a water basin 12, a water pump 14, water circulation conduits 16, a pump motor 18, a controller 20 for controlling the operation of the pump motor 18 and a control panel 22 for adjusting the settings on the controller 20. The invention is diagrammatically illustrated in FIG. 1.

The water basin 12 can be any suitable water basin capable of retaining a human being partially submerged below a level of water. In FIG. 1, the water basin 12 is illustrated as a portable spa, having a square perimeter 24. Other shapes and sizes can also be used. The water basin 12 can also be a bath tub-shaped basin.

The water basin 12 further comprises at least one drain opening 26.

In a typical embodiment, the invention comprises one or more water therapy stations 28 disposed within the water basin 12. In the embodiment illustrated in the drawings, the water basin 12 holds two water therapy stations 28.

A first water therapy station 28a comprises a first seating location 30a capable of retaining a seated human being. A second water therapy station 28b comprises a second seating location 30b capable of supporting a reclining human being. In a typical embodiment, both the first seating location 30a and the second seating location 30b are contoured to conform to the human body.

Each of the seating locations 30 comprises a plurality of water inlet openings 32. Each of the water inlet openings 32 is capable of projecting a high velocity stream of pulsating water against a specific portion of the anatomy of a human being disposed within the seating location 30. In a typical embodiment, each of the water inlet openings 32 comprise water jet nozzles 34 of the type well-known in the art.

Each water therapy station 28 comprises a separate and independent water circulation system. Each water circulation system includes a pump 14 and water circulation conduits 16. Each pump 14 is typically a centrifugal pump and has a suction side 36 and a discharge side 38. Appropriate water circulation conduits 16 connect the at least one water basin drain opening 26 to the suction side 36 of each pump 14 and connects the discharge side 38 of each pump 0.14 to the plurality of water inlet openings 32 at one of the seating locations 30.

In the embodiment illustrated in the drawings, the water circulation conduits 16 in each water therapy station 28 further comprise an ejector 40 disposed between the discharge side 38 of the pump 14 and the water inlet openings 32. Each ejector 40 is capable of drawing air into a water stream flowing from the pump 14 to water inlet openings 32 in one of the water therapy stations 28.

Preferably, the air drawn into a water stream flowing from the pump 14 to the water inlet openings 32 in each water therapy station 28 is provided by an air valve 42 disposed proximate to the seating location 30 in the water therapy station 28, so that a patient disposed at that water therapy station 28 can easily adjust the input of air within the incoming water by adjusting the air valve 42.

Each pump 14 is driven by an electric motor 18. In one embodiment, the motor 18 drives the pump 14 at a single speed. Alternatively, a variable speed electric motor may be used for the capability of driving the pump 14 at any one of a plurality of speeds.

Each motor 18, when started and stopped with a controller 20 (described below), is capable of driving a pump 14 in pulsating flow mode in a plurality of pulsating flow frequencies and durations. Specifically, when the motor 18 is suddenly turned on, the motor 18 drives the pump 14 and projects a pulse of water from the water inlet openings 32. When the motor 18 is suddenly turned off, the pump 14 suddenly stops, and no water flows from the water inlet openings 32.

Each motor 18 is controlled by a separate controller 20. In the embodiment illustrated in the drawings, the controller 20 adjusts the pulsation of the water by intermittently turning the electric motor 18 on and off. Each controller 20 is capable of adjusting the pulsing of water discharged from one of the pumps 14, both as to frequency and duration. In a typical embodiment, the frequency of flow pulsations from the pump 14 is variable for a plurality of settings between about 26 pulsations per minute and about 160 pulsations per minute. The velocity of water pulsing through each water inlet opening is typically between about 1 ft./sec. and about 10 ft./sec.

In a preferred embodiment, the controller 20 also adjusts the voltage of the electrical power driving the electric motor 18 so that the speed of the electric motor 18 can be varied during pulsation. By varying the speed of the electric motor 18 during pulsation, the amplitude of the pulses is adjusted by the controller 20.

A control panel 22 is operatively connected to each controller 20 and allows the user to quickly and easily set the intervals at which the controller 20 turns the electric motor 18 on and off, so as to adjust the frequency and duration of flow pulsations from the pump 14. Each control panel 22 is located proximate to each seating location 30 so that different patients sitting in different seating locations can independently adjust the frequency, duration and amplitude of flow pulsations through water openings in that patient's particular seating location 30.

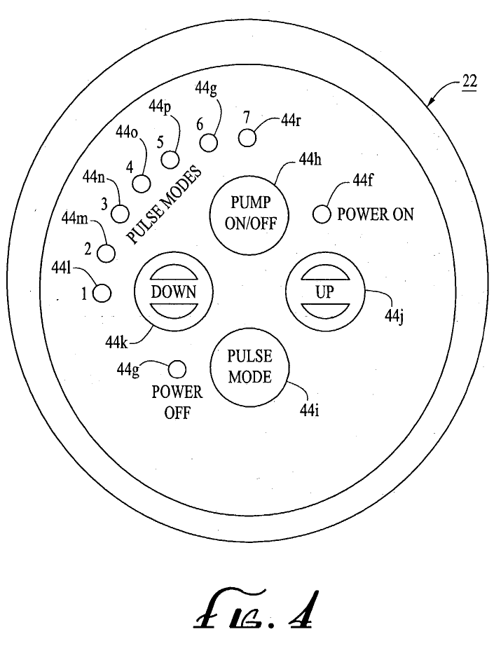

As illustrated in FIG. 3, the control panel 22 can have five buttons 44. A first button 44a is a power button to turn off and turn on the electrical power to the system. A second button 44b turns the pump 14 on and off. A third button 44c turns the pulse mode adjustment function on and off. A fourth button 44d instructs the controller 20 to go forward through a series of preset massage modes, each typically varying in duration, frequency and amplitude. In the illustrated embodiment of the invention, when the pulse mode adjustment function is turned on, the controller 20 turns the electric motor 18 on and off at preset frequencies, for preset durations, and at preset speeds, corresponding to the massage mode selected on the control panel 22. A fifth button 44e allows the patient to go backwards through the massage mode series.

As illustrated in FIG. 4, the control panel 22 can have 13 buttons 44. A first button 44f turns the power on. A second button 44g turns the power off. A third button 44h turns the pump on and off. A fourth button 44i turns the pulse mode on and off. A fifth button 44j instructs the controller 20 to go forward through a series of pre-set massage modes, each typically varying in duration, frequency and amplitude. A sixth button 44k allows the user to go backwards through the massage modes. Buttons 44l-44r allow the user to select any of 7 different pulse modes.

In one typical embodiment of the invention, each control panel 22 can toggle its respective controller 20 through one of seven different massage mode settings as follows:

| Setting | Duration | Frequency |
|---|---|---|
| 1 | 0.5 secs. on & 2 secs. off | 0.4 pulses/sec. |
| 2 | 0.5 secs. on & 1 sec. off | 0.6 pulses/sec. |
| 3 | 0.5 secs. on & 0.5 secs. off | 1.0 pulses/sec. |
| 4 | 0.375 secs. on & 0.125 secs. off | 2.0 pulses/sec. |
| 5 | 0.125 secs. on & 0.125 secs. off | 4.0 pulses/sec. & |
| | followed by 0.625 secs. on & | 1.33 pulses/sec. |
| | 0.125 secs. off | |
| 6 | 0.375 secs, on & 0.25 secs. off | 1.6 pulses/sec. |
| 7 | 0.25 secs. on & 0.25 secs. off | 2.0 pulses/sec. & |
| | followed by 2.0 secs. on & | 0.44 pulses/sec. |
| | 0.25 secs. off | |

The invention provides a water therapy system which is far more convenient to operate for the user than water therapy stations of the prior art. Unlike water therapy devices of the prior art, a patient can readily adjust water pulsations to his or her body through several different adjustment settings without having to leave the water basin.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. An adjustable water therapy combination comprising:
(a) a water basin capable of retaining a human being partially submerged below a level of water, the water basin having at least one drain opening and having a plurality of water input openings;
(b) a water pump having a suction side and a discharged side;
(c) water circulation conduits connecting the at least one water basin drain opening to the suction side of the pump and connecting the discharge side of the pump to the plurality of water input openings in the water basin;
(d) an electric motor for driving the pump;
(e) a controller capable of turning the motor on and off, the controller also having settings for adjusting the pulsing of water discharged from the pump, both as to frequency and duration, the controller being capable of pulsing the electric motor on and off so as to drive the pump in pulsing flow mode in a plurality of pulsing flow frequencies and durations; and
(f) a control panel operatively connected to the controller and being accessible to a user disposed within the water basin, for adjusting the settings on the controller and for adjusting the frequency and duration of flow pulsations from the pump.

2. The adjustable water therapy combination of claim 1 wherein the controller is capable of pulsing the electric motor on and off so as to drive the pump in pulsing flow mode in a plurality of pulsing flow frequencies, durations and amplitudes.

3. An adjustable water therapy combination comprising:
(a) a water basin capable of retaining a human being partially submerged below a level of water, the water basin having at least one drain opening; and
(b) at least one water therapy station, each station comprising:
(i) a seating location capable of supporting a seated or reclining human being;
(ii) a plurality of water inlet openings defined within the seating location;
(iii) a water pump having a suction side and a discharge side;
(iv) water circulation conduits connecting the at least one water basin drain opening to the suction side of the pump and connecting the discharge side of the pump to the plurality of water input openings;
(v) an electric motor for driving the pump;
(vi) a controller capable of turning the motor on and off, the controller also having settings for adjusting the pulsing of water discharged from the pump, both as to frequency and duration, the controller being capable of pulsing the electric motor on and off so as to drive the pump in pulsing flow mode in a plurality of pulsing flow frequencies and durations;
(vii) a control panel operatively connected to the controller and being accessible to a user disposed within the water basin, for adjusting the settings on the controller and for adjusting the frequency and duration of flow pulsations from the pump.

4. The adjustable water therapy combination of claim 3 wherein the controller is capable of pulsing the electric motor on and off so as to drive the pump in pulsing flow mode in a plurality of pulsing flow frequencies, durations and amplitudes.

5. The adjustable water therapy combination of claim 3 wherein the seating location is contoured to conform to the human body.

6. The adjustable water therapy combination of claim 3 wherein the at least one water therapy station comprises a plurality of water therapy stations.

7. The adjustable water therapy combination of claim 3 wherein the water inlet opening comprises water jet nozzles.

8. The adjustable water therapy combination of claim 3 wherein the water circulation conduits comprise a ejector disposed between the discharge side of the pump and the water inlet openings, the ejector being capable of drawing air into a water stream flowing from the pump to the water inlet openings.

9. The adjustable water therapy combination of claim 8 wherein air drawn into the ejector is provided by an air valve disposed proximate to the seating location, the air valve being accessible to a user disposed within the seating location.

10. The adjustable water therapy combination of claim 3 wherein the frequency of flow pulsations from the pump is variable between about 26 per minute and about 160 per minute.

11. The adjustable water therapy combination of claim 3 wherein the velocity of water pulsing through each of the water inlet openings is between about 1 ft./sec. and about 10 ft./sec.

12. An adjustable water therapy combination comprising:
(a) a water basin capable of retaining a human being partially submerged below a level of water, the water basin having at least one drain opening; and
(b) a plurality of water therapy stations, each station comprising:
(i) a seating location capable of supporting a seated or reclining human being, the seating location being contoured to conform to the human body;
(ii) a plurality of water inlet openings defined within the seating location, the water inlet openings comprising water jet nozzles;
(iii) a water pump having a suction side and a discharge side;
(iv) water circulation conduits connecting the at least one water basin drain opening to the suction side of the pump and connecting the discharge side of the pump to the plurality of water input openings, the water circulation conduits comprising a ejector disposed between the discharge side of the pump and the water inlet openings, the ejector being capable of drawing air into a water stream flowing from the pump to the water inlet openings;
(v) an electric motor for driving the pump;
(vi) a controller capable of turning the motor on and off, the controller also having settings for adjusting the pulsing of water discharged from the pump, both as to frequency, duration and amplitude, the controller being capable of pulsing the electric motor on and off so as to drive the pump in pulsing flow mode in a plurality of pulsing flow frequencies, durations and pump speeds;
(vii) a control panel operatively connected to the controller and being accessible to a user disposed within the water basin, for adjusting the settings on the controller and for adjusting the frequency, duration and amplitude of flow pulsations from the pump; and
(viii) an air valve disposed proximate to the seating location, the air valve providing air to the ejector, the air valve being accessible to a user disposed within the seating location.

11. The adjustable water therapy combination of claim 11 wherein the frequency of flow pulsations from each pump variable is between about 26 per minute and about 160 per minute.

12. The adjustable water therapy combination of claim 11 wherein the velocity of water pulsing through each of the water inlet openings is between about 1 ft./sec. and about 10 ft./sec.
